(19) United States
(12) Patent Application Publication
(10) Pub. No.: US 2011/0109752 A1
(43) Pub. Date: May 12, 2011

(54) IMAGE SENSOR WITH SHAKING COMPENSATION

(75) Inventor: Ho Seong Lee, San Jose, CA (US)

(73) Assignee: OMNIVISION TECHNOLOGIES, INC., Santa Clara, CA (US)

(21) Appl. No.: 12/616,583

(22) Filed: Nov. 11, 2009

(51) Int. Cl. H04N 5/228

(52) U.S. Cl. 348/208.1; 348/208.4; 348/E05.031

(57) ABSTRACT

A camera includes a main pixel array, one or more shaking detection pixel groups, and logic circuitry. The main pixel array can generate image frames of an image at an image frame rate. The one or more shaking detection pixel groups can generate shaking detection data where one or more pixels of the first shaking detection pixel group are sampled at a rate that is faster than the image frame rate. The logic circuitry can evaluate the shaking detection data to select a frame of the generated image frames after receiving a picture taking signal.

### TECHNICAL FIELD

This disclosure relates generally to imaging sensors, and in particular but not exclusively, relates to imaging sensors having elements for shaking compensation.

### BACKGROUND INFORMATION

Integrated circuits have been developed to reduce the size of components used to implement circuitry. For example, integrated circuits have been using ever-smaller design features, which reduces the area used to implement the circuitry, such that design features are now well under the wavelengths of visible light. With the ever-decreasing sizes of image sensors and the individual pixels that are part of a sensing array, it is important to more efficiently capture charges that are formed when incident light illuminates the sensing array. Further, the effect of camera motion (such as shaking caused by hand-held cameras) more adversely affects the quality of images captured by the sensing arrays of ever-decreasing sizes.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a block diagram illustrating an imaging sensor, in accordance with an embodiment of the invention.

FIG. 2 is an illustration of sample shaking detection pixel groups, in accordance with embodiments of the invention.

FIG. 3 is a timing diagram illustrating read out of data from shaking detection pixel groups and the main pixel array, in accordance with an embodiment of the invention.

FIG. 4 is a timing diagram illustrating read out of data from the shaking detection pixel groups at a rate k times the main pixel array, in accordance with an embodiment of the invention.

FIG. 5 is a timing diagram illustrating read out of data from the shaking detection pixel groups at a rate four times the main pixel array, in accordance with an embodiment of the invention.

FIG. 6 is a timing diagram illustrating different resolution and frame rates between preview and capturing modes.

FIG. 7 is a timing diagram illustrating different resolution and frame rates between preview and capturing modes.

FIG. 8 (PRIOR ART) is a timing diagram illustrating different resolution and frame rates between preview and capturing modes.

FIG. 9 is a timing diagram illustrating different resolution and frame rates between preview and capturing modes, in accordance with an embodiment of the invention.

FIG. 10 is a timing diagram illustrating a time period in which anti-shake calculations can be performed, in accordance with an embodiment of the invention.

FIG. 11 is a flow diagram illustrating main pixel frame selection using shaking detection pixel groups, in accordance with an embodiment of the invention.

### DETAILED DESCRIPTION

Embodiments of an image sensor with shaking compensation are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. The term “or” as used herein is normally meant to encompass a meaning of an inclusive function, such as “and/or.” The term “camera” as used herein can also refer to multifunction devices (such as cell phones) that incorporate camera-like functions and often share components such as memory and processing functions.

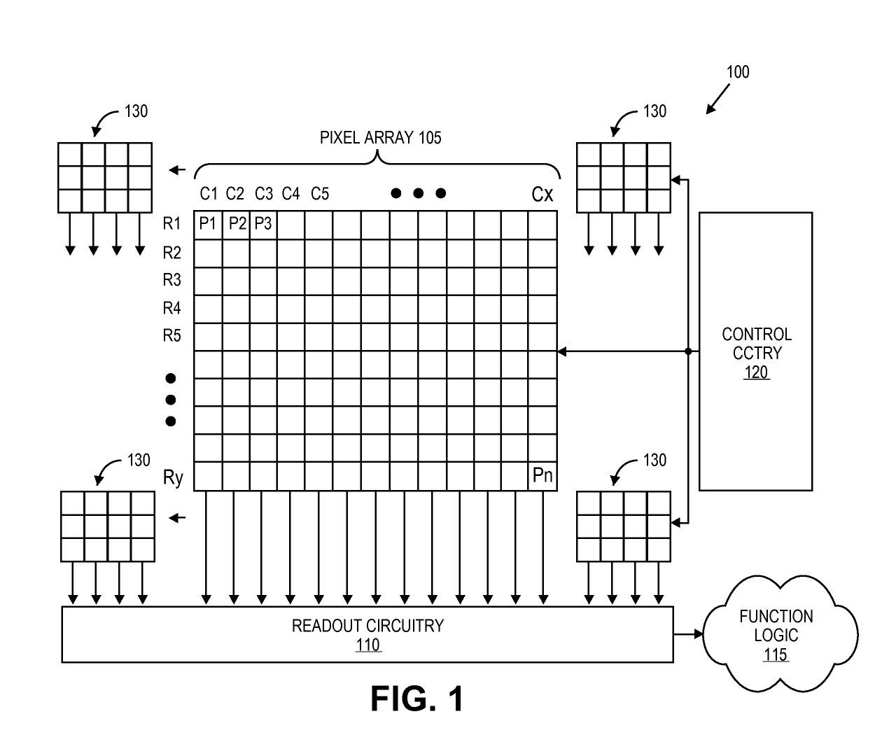

FIG. 1 is a block diagram illustrating an imaging sensor 100, in accordance with an embodiment of the invention. Embodiments of the present invention can be practiced using front side or back side illuminated imaging sensors. The illustrated embodiment of imaging sensor 100 includes a pixel array 105, read out circuitry 110, function logic 115, control circuitry 120, and one or more shaking detection pixel groups 130. The one or more shaking detection pixel groups 130 can be disposed as illustrated, although other locations, shapes, orientations, and sizes can be used.

Pixel array 105 is a two-dimensional (“2D”) array of imaging pixels (e.g., pixels P1, P2 . . . , Pn). In one embodiment, each pixel is an active pixel sensor (“APS”), such as a complementary metal-oxide-semiconductor (“CMOS”) imaging pixel. Each pixel typically has a photosensitive region, such as a photodiode region, which is used to collect charge that is generated by light incident on the pixel. As illustrated, each pixel is arranged into a row (e.g., rows R1 to Ry) and a column (e.g., column C1 to Cx) to acquire image data of a person, place, or object, which can then be used to render a 2D image of the person, place, or object. Each pixel can comprise subpixel groups (such as four pixels having color micro-lenses arranged in a Bayer pattern) for different colors.

After each pixel has acquired its image data or image charge, the image data is read out by read out circuitry 110 and transferred to function logic 115. Read out circuitry 110 may include amplification circuitry, analog-to-digital conversion circuitry, or otherwise. Function logic 115 may include logic circuitry such as discrete logic, one or more processors, and/or memory (including lookup tables) for processing shaking detection pixel group data. Function logic can also be used to store or manipulate the image data by applying post image effects (e.g., crop, rotate, remove red eye, adjust brightness, adjust contrast, or otherwise). In one embodiment, read out circuitry 110 may read out a row of image data at a time along read out column lines (illustrated) or may read out the image data using a variety of other techniques (not illustrated), such as a serial read out or a full parallel read out of all pixels simultaneously.

Control circuitry 120 is coupled to pixel array 105 to control operational characteristic of pixel array 105. For example, control circuitry 120 may generate a shutter signal for controlling image acquisition. The shutter signal can be generated in response to a user pressing a shutter button, receiving a signal from a strobe light, an expiration of a timer signal, and the like.

In one embodiment, a color pattern (e.g. a Bayer pattern) and image processing may be used to reconstruct the RGB colors for each pixel. In another embodiment, a plurality of separate image sensors may be used to determine the RGB colors for an individual pixel by combining the image of the same pixel from each sensor to reconstruct the RGB colors for the individual pixel.

The one or more shaking detection pixel groups 130 are used, for example, to reduce blurring that can result from taking a picture using a hand-held camera. A picture taken by a mobile camera can be blurred due to, for example, hand shaking, movement caused by a mechanical shutter, or pushing the snapshot button. The teachings of the present disclosure allow for reduced blurring effect caused by such movements within a final captured image. In various embodiments, the teachings can be implemented in a cost effective manner in order to be useful in consumer electronics products.

In contrast, conventional methods often reduce the impact of camera movement on final captured image by using mechanical suspensions with counter acting drive mechanisms. Often an electromechanical motion sensing device is included in the system. Other conventional methods may include applying a data processing algorithm to the entire set of data with each frame captured, which requires a large amount of memory and/or a filter circuit that requires a large amount of complicated logic software or logic circuitry. The typically high cost of the conventional solutions often makes them less acceptable for lower cost consumer electronics.

The one or more shaking detection pixel groups 130 can be disposed as illustrated, although other locations can be used. The pixels which are in the “shaking detection pixel groups 130 can be any size depending on sensor design. One or more shaking detection pixel groups 130 can be implemented in various embodiments depending on cost considerations and it can be located in any place on the sensor array depending on the design and application requirements. Generally, more shaking detection pixel groups 130 results in better performance, and more pixels within each group results in better performance.

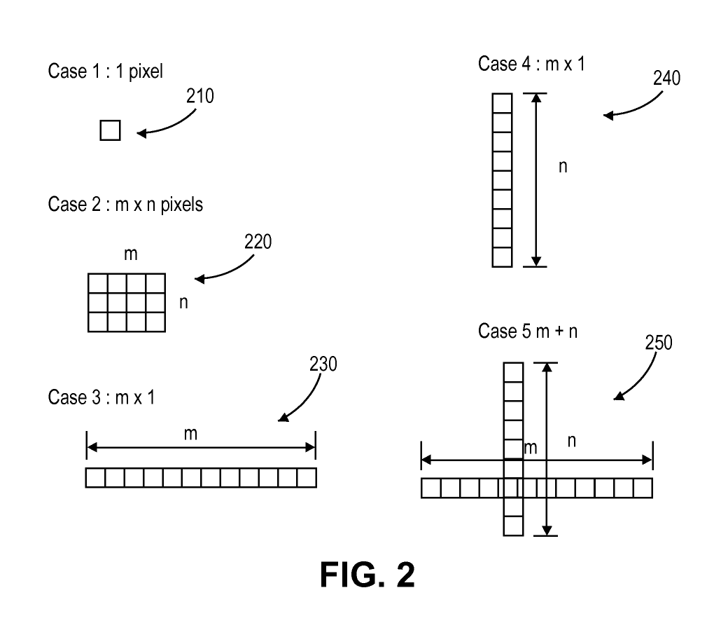

FIG. 2 is an illustration of sample shaking detection pixel groups. One or more extra pixel groups can be used to detect the amount of shaking of an image. Each extra pixel group can be operated with a faster frame rate or faster read out timing (such as at a rate that is twice or more) than reading out image information from the main pixel array 105.

Each shaking detection pixel group 130 can be arranged as (for example) a single pixel 210, an m-by-n array 220, an m-long row 230, an n-high column 240, or an m-long row and n-high column 250. Shaking detection pixel groups 130 can be formed by using a subset (which includes the set, by definition) of a pixel array. Thus the one or more shaking detection pixel groups 130 can be formed from subsets of pixels in an array sharing the same substrate as the main pixel array 105. In other embodiments separate substrates can be used for the one or more shaking detection pixel groups 130 and the main pixel array 105.

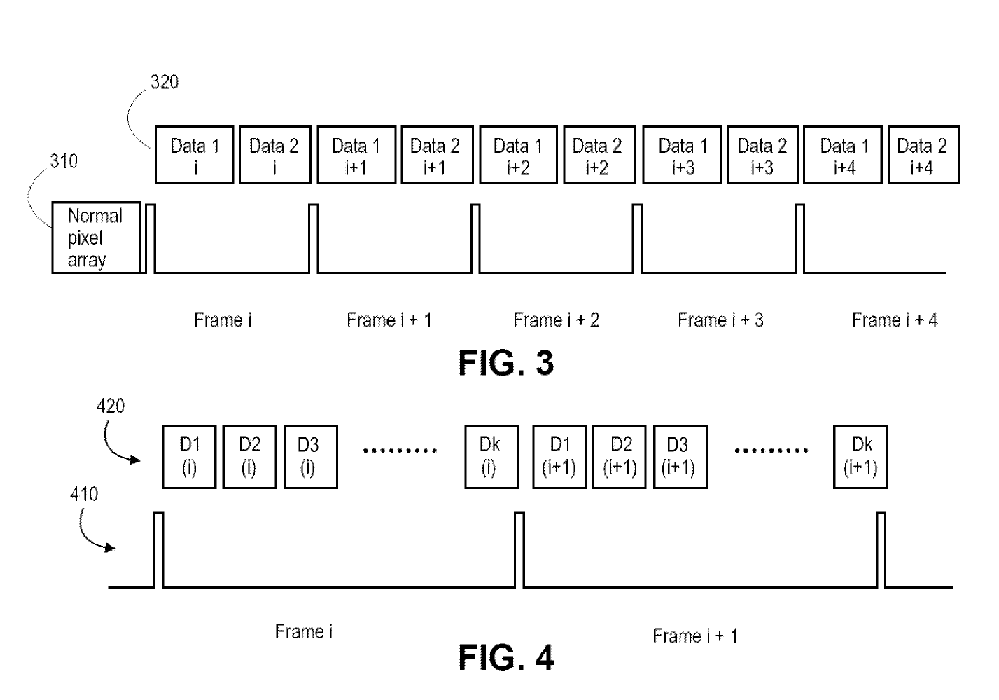

As discussed above, the shaking detection pixel groups 130 are typically read out at a rate that is faster than the rate at which the main pixel array is read out. FIG. 3 is a timing diagram illustrating read out of data from the shaking detection pixel groups 130 and the main pixel array 105. Row 310 illustrates the rate at which frame read outs occur from the main pixel array 105. Row 320 illustrates the rate at which read out occurs from the shaking detection pixel groups 130. In the illustrated embodiment, row 320 illustrates the rate at which read out occurs from the shaking detection pixel groups 130 is twice as fast as the read out that occurs from the main pixel array 105.

The data in row 320 is the average luminance value for shaking detection pixel groups 130. In the illustrated example, the “shaking amount” for each frame can be calculated as:

shaking amount for Framei=ABS(Data1(i)−Data2(i)),

where ABS(x) is the absolute value for x.

More generally, the equation can be described as:

shaking amount for Framei=STD(Data1(i),Data2(i) . . . Datak(i)),

where STD(x(k)) is the standard deviation value for Data 1(i), Data2(i) . . . Datak(i)

Where multiple (such as four) groups are used (group A, group B, group C, group D), the shaking amount can be calculated as:

shaking amount for Pixel groupA in Framei=STD(DataA1(i),DataA2(i) . . . DataAk(i)),

shaking amount for Pixel groupB in Framei=STD(DataB 1(i),DataA2(i) . . . DataB k(i)),

shaking amount for Pixel groupC in Framei=STD(DataC1(i),DataA 2(i) . . . DataC k(i)),

shaking amount for Pixel groupD in Frame i=STD(DataD1(i),DataA2(i) . . . DataDk(i)).

A final shaking amount can be calculated by using an average value method, a greatest value method, or otherwise. A final shaking amount calculated using an average value method may be determined as follows:

final shaking amount for framei=(shaking amount for Pixel groupA in FrameI+shaking amount for Pixel groupB in FrameI+shaking amount for Pixel groupC in FrameI+shaking amount for Pixel groupD in Framei)/4.

A final shaking amount calculated using a greatest value method can be determined as outlined below. Assuming the shaking amount for Pixel group A in Frame I is the largest value in Frame I, then the final shaking amount is:

final shaking amount for frameI=shaking amount for Pixel groupA in FrameI

FIG. 4 is a timing diagram illustrating read out of data from the shaking detection pixel groups 130 at a rate k times the main pixel array 105. Row 410 illustrates the rate at which frame read outs occur from the main pixel array 105. Row 420 illustrates the rate at which read out occurs from the shaking detection pixel groups 130. Thus, row 420 illustrates the rate at which read out occurs from the shaking detection pixel groups 130 is k times as fast as the read out that occurs from the main pixel array 105.

Where the final shaking amount is applied at a rate k times faster than the normal pixel read out period, then a “shaking amount” can be described as:

shaking amount for Framei=STD(Data1(i),Data2(i) . . . Datak(i)),

where STD(x(k)) is the standard deviation value for Data 1(i), Data2(i) . . . Datak(i).

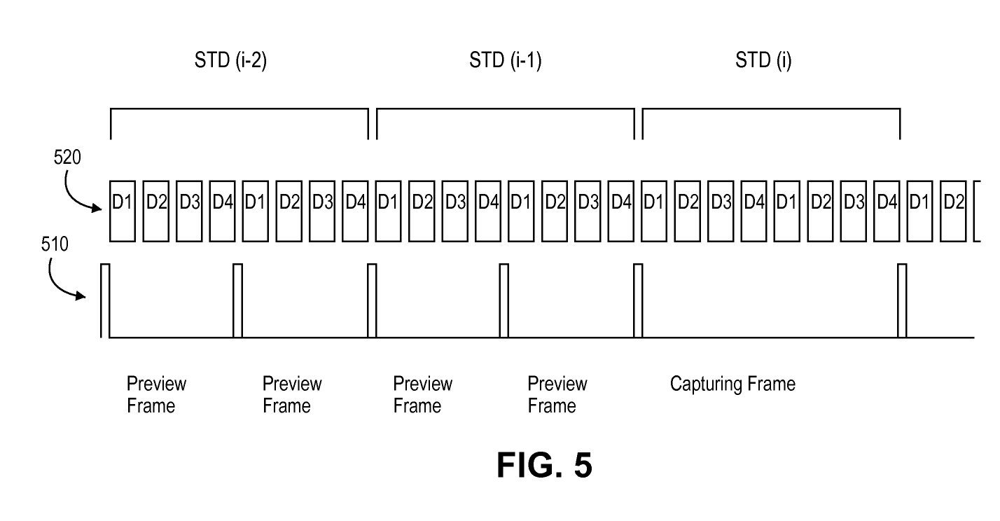

FIG. 5 is a timing diagram illustrating read out of data from the shaking detection pixel groups 130 at a rate four times main pixel array 105. Row 510 illustrates the rate at which frame read outs occur from main pixel array 105. Row 520 illustrates the rate at which read out occurs from the shaking detection pixel groups 130. Thus, row 520 illustrates that the rate at which read out occurs from the shaking detection pixel groups 130 is independent of the actual read out that occurs from the main pixel array 105.

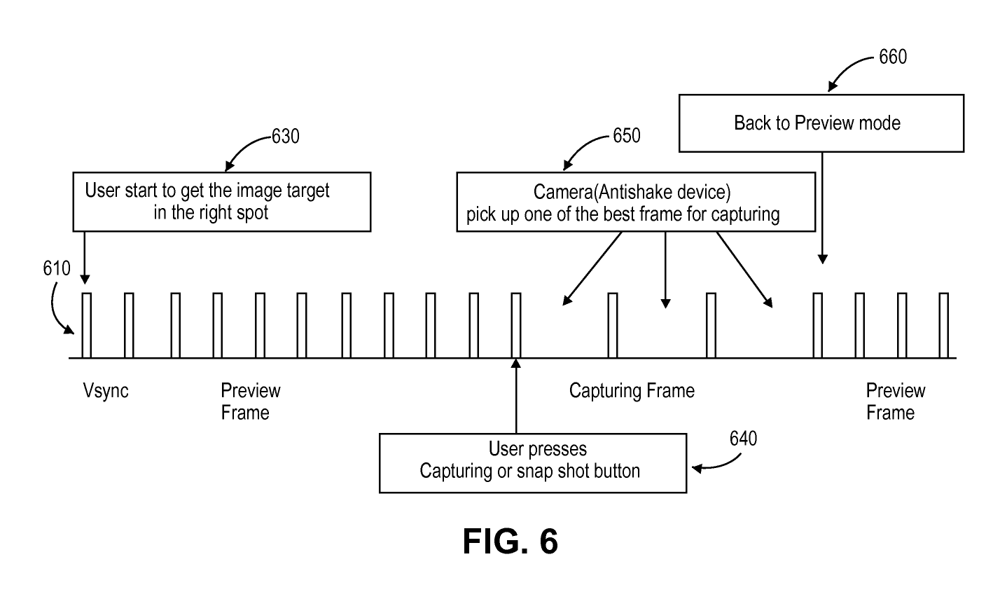

FIG. 6 is a timing diagram illustrating different resolution and frame rates between preview and capturing modes. Row 610 illustrates the rate at which frame read outs occur from the main pixel array 105. Time 630 illustrates when a user starts getting the image target in a desired spot. As illustrated in row 610, preview frame read outs are made during time 630. Time 640 illustrates when a user presses a “snapshot” button. Time 650 illustrates a period in time in which capturing frames are read out from the main pixel array 105. A camera anti-shake device can select any of the capturing frames as a best frame. At time 660, the camera returns to a preview mode where preview frame read outs are made. However, in many cases, because the user is usually trying to get the right image target in the right spot several seconds before pressing the snapshot button, the camera has seen several similar frames before the snapshot button is pressed.

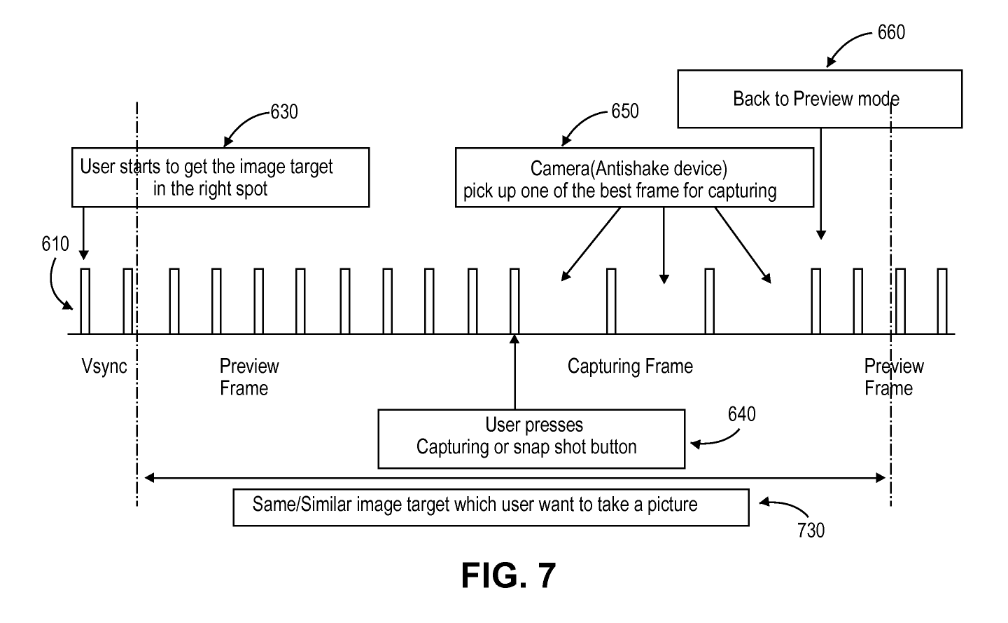

FIG. 7 is a timing diagram illustrating different resolution and frame rates between preview and capturing modes. Time period 730 illustrates a time period in which a same and/or similar image target is presented for which the user would like to capture. Because conventional or traditional anti-shake devices usually use a general or special high pass filter or anti-shake filter which uses normal sensor pixel data, it is difficult to correlate data from frames having different resolutions and frame rates.

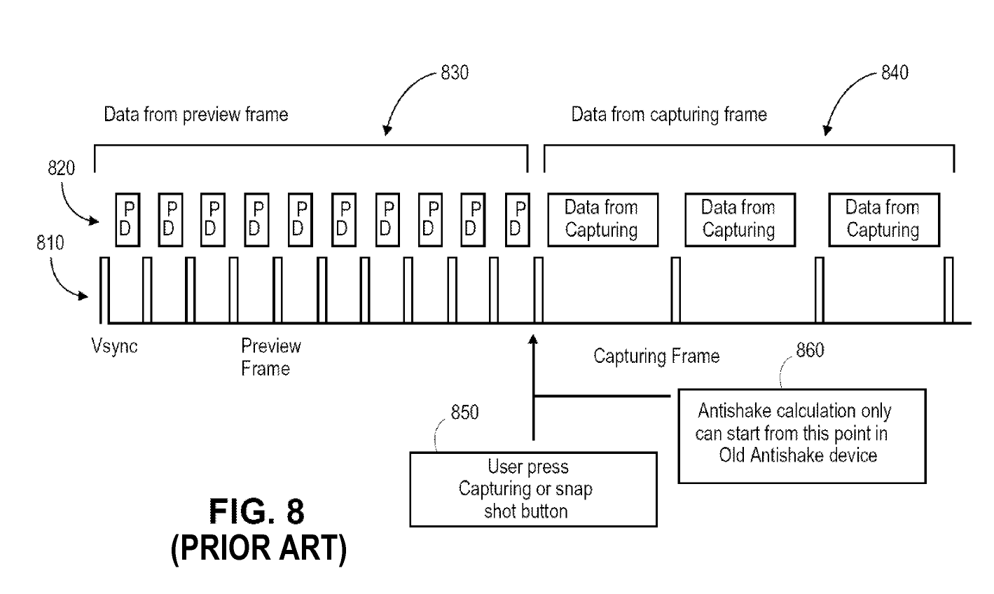

FIG. 8 is a timing diagram illustrating a conventional technique using different resolution and frame rates between preview and capturing modes. Row 810 illustrates the rate at which frame read outs occur from the main pixel array 105. Row 820 illustrates the rate at which a preview frame's anti-shake data (PD) is also read out from the main pixel array. During preview mode 830, the data is typically read out with a faster frame rate but at a lower resolution. During frame capturing mode 840, the data is typically read out with a slower frame rate but at a higher resolution.

Because of the difficulty in correlating data from frames having different resolutions and frame rates, even though a camera can have same/similar image target from several frames before the user presses the capturing/snapshot button at time 850, the conventional an anti-shake device normally starts the anti-shake calculation or decision only after the user presses the capturing/snapshot button at time period 860. This limitation typically results in a very slow anti-shake response time or requires a large frame buffer to improve performance. In contrast, the present disclosure has a different read out period from the main pixel array. Because the “best frame” decision uses data from the shaking detection pixel groups 130, the shaking amount can be independently calculated.

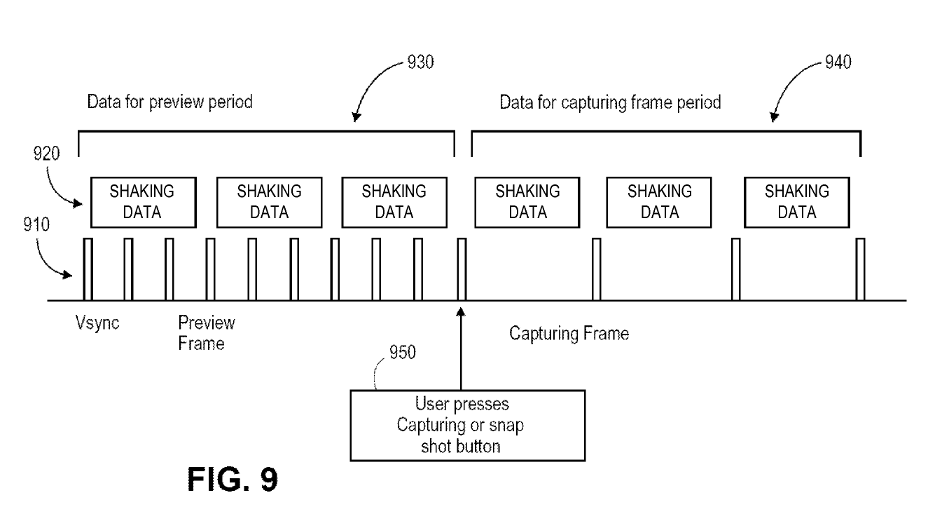

FIG. 9 is a timing diagram illustrating different resolution and frame rates between preview and capturing modes, in accordance with an embodiment of the invention. Row 910 illustrates the rate at which frame read outs occur from the main pixel array 105. Row 920 illustrates the rate at which shaking detection data is readout from shaking detection pixel groups 130. During preview mode 930, the shaking detection data can be read out with the same rate and resolution as the shaking detection data read out during frame capturing mode 940.

Because different read out periods and separate pixels are disclosed herein, the anti-shake related data can be calculated independently from the normal pixel array frame rate or resolution. Because the anti-shake related data can be calculated independently from the normal pixel array frame rate or resolution, the anti-shake related data can be calculated before the user presses the capturing/snapshot button at time 950.

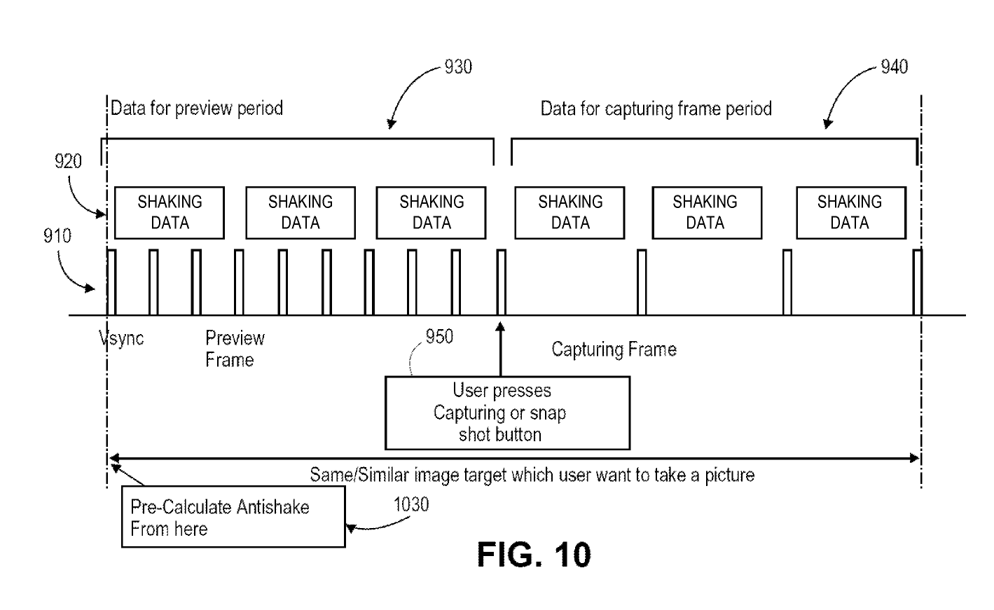

FIG. 10 is a timing diagram illustrating a time period in which anti-shake calculations can be performed. Anti-shake calculations can commence starting from time 1030. Because the image being captured is already focused several frames before the user presses the capturing button, a pre-shutter press calculation can be performed for better anti-shake algorithm performance.

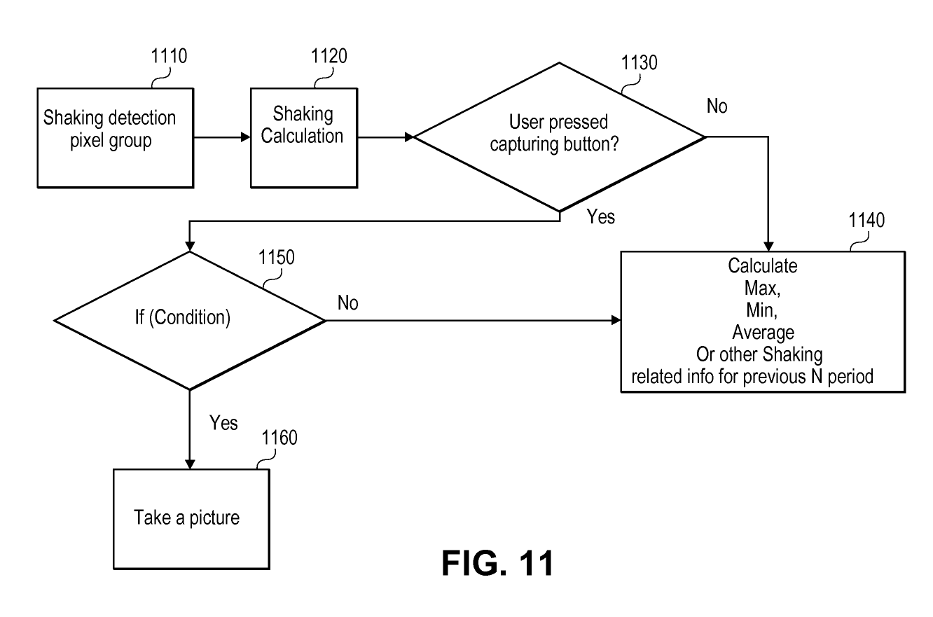

FIG. 11 is a flow diagram illustrating main pixel frame selection using shaking detection pixel groups. In operation 1110, shaking detection pixel group data is received from one or more shaking detection pixels groups. The shaking detection pixel group data is transmitted at a rate that is faster than a frame rate from the main pixel array. Average luminance information can be extracted from the received shaking detection pixel data.

In operation 1120, a shaking calculation is performed. The shaking information can be determined using shaking detection pixel group data using the following (or equivalent, similar and/or adapted) equation:

Shaking amount for periodi=STD(Data1(i),Data2(i) . . . Datak(i))

where STD(x(k)) is the standard deviation value for Data 1(i), Data2(i) . . . Datak(i).

In operation 1130, it is determined whether a picture taking signal has been received. The picture taking signal can be, for example, a user has pressed a shutter button on a camera, a strobe signal, a timer signal, or the like. If the picture taking signal has been received, the logic flow proceeds to operation 1140.

In operation 1140, shaking detection pixel group data is used to calculate statistics such as Max, Min, Average, and/or other shaking related information for the previous N periods. The statistics can be used to determine whether a captured image frame would be potentially acceptable by, for example, comparing the calculated values with predetermined limits. Max is a value representing the maximum shaking value among N periods. Min is a value representing the minimum shaking value during N periods. Average is a value representing the average shaking value for N periods. N is an integer number representing the number of periods over which the Max, Min, and Average values can be calculated. The value for N can be selected by an application designer in accordance with speed, power, cost, and accuracy tradeoffs.

If in operation 1130 it is determined that the picture taking signal has not been received, the logic flow proceeds to operation 1150, where the “If (condition)” is evaluated. The If (Condition) can be evaluated using shaking detection pixel group derived data such as Max, Min, or Average and current period shaking information. For example, the current period shaking value can be scaled and compared with the values of Max, Min, or Average to determine whether, for example, to select a current frame. If a scaled current period value is greater than the Max value, and is greater than the Average value, and is less than the Min value, then the process flow proceeds to operation 1160 when an image frame from the main pixel array is selected as the photograph associated with the received picture taking signal. If the result of the comparisons is negative, then the process flow proceeds to operation 1140, which is discussed above. In various embodiments, acceptable values to determine frame selection can be expressed as percentages, ranges of permissible values, lookup tables, or the like. The determination of whether to select a current frame as a final picture can be determined by using one or several conditions as illustrated in the above example. Threshold values for the logic conditions can also be selected by an application designer in accordance with speed, power, cost, and accuracy tradeoffs.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera, comprising:
a main pixel array for generating image frames of an image at an image frame rate;
a first shaking detection pixel group for generating shaking detection data wherein one or more pixels of the first shaking detection pixel group are sampled at a rate that is faster than the image frame rate; and
logic circuitry for evaluating the shaking detection data to select a frame of the generated image frames after receiving a picture taking signal.

2. The camera of claim 1, further comprising a second shaking detection pixel group for generating shaking detection data where one or more pixels of the second shaking detection pixel group are sampled at a rate that is faster than the image frame rate.

3. The camera of claim 1, wherein the first shaking detection pixel group includes a plurality of pixels arranged in rows and columns.

4. The camera of claim 3, wherein the number of pixels in each row is the same.

5. The camera of claim 1, wherein the image frame rate comprises a capturing frame rate and wherein the one or more pixels of the first shaking detection pixel group are each sampled at a rate that is at least twice as fast as the capturing frame rate.

6. The camera of claim 1, further comprising capturing preview frames with the main pixel array before receiving the picture taking signal.

7. The camera of claim 6, wherein the one or more pixels of the first shaking detection pixel group are sampled at a rate that is faster than a capture rate of the preview frames.

8. The camera of claim 6, wherein one of the image frames is selected in response to the picture taking signal.

9. The camera of claim 1, wherein a logic function is performed on the shaking detection data received during a period of time determined by the image frame rate.

10. The camera of claim 9, wherein the logic function is a standard of deviation function that is performed on shaking detection data received during a period determined by the image frame rate.

11. The camera of claim 9, wherein the logic function is performed before receiving the picture taking signal.

12. The camera of claim 11, wherein the logic function performed before receiving the picture taking signal is used to select an image frame from the main pixel array after receiving the picture taking signal.

13. The camera of claim 1, wherein the logic function performed compares a calculated value with a predetermined limit.

14. The camera of claim 1, wherein the main pixel array and the first shaking detection pixel group are formed on the same substrate.

15. A method for image stabilization, comprising:
receiving incident light of an image at a camera,
illuminating a main pixel array and a first shaking pixel detection group with the received incident light;
generating image frames in response to the incident light illuminating the main pixel array;
generating shaking detection data by sampling one or more pixels of the first shaking detection pixel group at a rate that is faster than the image frame rate;
receiving a picture taking signal; and
selecting a final image from the generated image frames in response to the calculated pixel shaking data and the received picture taking signal.

16. The method of claim 15, further comprising generating shaking detection data by sampling one or more pixels of a second shaking detection pixel group at a rate that is faster than the image frame rate, wherein the received incident light illuminates the second shaking detection pixel group.

17. The method of claim 15, further comprising evaluating the shaking detection data to determine a time in which to select a frame of the generated image frames to associate with the received picture taking signal.

18. The method of claim 15, further comprising generating preview frames using the main pixel array before receiving the picture taking signal.

19. The method of claim 18, further comprising performing a logic function on the shaking detection data received during a period of time determined by the image frame rate.

20. The method of claim 19, wherein the logic function is performed before receiving the picture taking signal.

21. An imaging sensor comprising:
a substrate;
a main pixel array formed in the substrate, wherein the main pixel array is arranged to generate image frames of an image at an image frame rate;
a first shaking detection pixel group formed in the substrate, wherein the first shaking detection pixel group is arranged to generate shaking detection data where one or more pixels of the first shaking detection pixel group are sampled at a rate that is at least twice as fast as the image frame rate; and
logic circuitry for evaluating the shaking detection data before receiving a picture taking signal and wherein a frame is selected in response to the evaluated shaking detection data after receiving the picture taking signal.

22. The imaging sensor of claim 21, further comprising a second shaking detection pixel group located separate from the first shaking detection pixel group for generating shaking detection data where one or more pixels of the second shaking detection pixel group are sampled at a rate that is faster than the image frame rate.

23. The imaging sensor of claim 22, wherein the image frames are generated in response to the picture taking signal and wherein the image frames comprise image capture frames.
